(19) United States
(12) Patent Application Publication
(10) Pub. No.: US 2026/0238889 A1
(43) Pub. Date: Aug. 13, 2026

(54) METHOD AND SYSTEM FOR SINGLE-PHOTON IMAGING

(71) Applicant: THE GOVERNING COUNCIL OF THE UNIVERSITY OF TORONTO, Toronto (CA)

(72) Inventors: Kiriakos Neoklis KUTULAKOS, Toronto (CA); David Brian LINDELL, Toronto (CA); Sotirios NOUSIAS, Toronto (CA); Mian WEI, Toronto (CA)

(21) Appl. No.: 19/156,625

(22) PCT Filed: Feb. 26, 2024
(86) PCT No.: PCT/CA2024/050236

§ 371 Date: Aug. 14, 2025

Related U.S. Application Data
(60) Provisional application No. 63/487,236, filed on Feb. 27, 2023.
(60) Provisional application No. 63/513,170, filed on Jul. 12, 2023.

(51) Int. Cl. H04N 23/95

(52) U.S. Cl. CPC H04N 23/95

(57) ABSTRACT

There is provided a system and method for single-photon imaging. The method including: receiving a plurality of asynchronous, or partially asynchronous, single-photon detections and an absolute timestamp associated with each one of the received single-photon detections; performing probing measurements to determine a sum of values of a probing function on the single-photon detection values at each of the absolute timestamps; reconstructing a continuous-time flux function from the probing measurements; and outputting the reconstructed continuous-time flux function or an integral thereof.

### TECHNICAL FIELD

The following relates generally to photon processing and photonics, and more specifically, to a method and system for single-photon imaging.

### BACKGROUND

A basic rule of thumb in high-speed imaging is that speed needs light; i.e., the faster a scene changes, the more light that is needed to image it accurately without excessive noise or motion blur. High-speed light sources, fast cameras, and depth sensors have made it possible to image dynamic phenomena occurring in ever-smaller time intervals with the help of actively-controlled light sources and synchronization. To collect enough light, the same picosecond-scale or nanosecond-scale event may be imaged millions of times by operating a camera and a source in lockstep, at MHz repetition rates or more. Unfortunately, while these techniques do capture ultra-fast events, they cannot simultaneously capture slower events as well because time wraps back to zero at the end of each sync period. As a result, using such techniques, events spanning multiple sync periods are essentially broken up into single-period events and subsequently summed. This blurs out anything that occurs over timespans longer than a sync period.

### SUMMARY

In an aspect, there is provided a processor-implemented method for single-photon imaging, the method comprising: receiving a plurality of asynchronous, or partially asynchronous, single-photon detections and an absolute timestamp associated with each one of the received single-photon detections; performing probing measurements to determine a sum of values of a probing function on the single-photon detection values at each of the absolute timestamps; reconstructing a continuous-time flux function from the probing measurements; and outputting the reconstructed continuous-time flux function or an integral thereof.

In a particular case of the method, the probing function is performed on frequencies from 0 to a maximum recoverable frequency, where each of the frequencies are separated by a frequency step.

In another case of the method, the frequency step is determined as 0.6/t, where t is a total acquisition time.

In yet another case of the method, the probing function approximates the flux function up to an additive noise function.

In yet another case of the method, the probing function is a continuous-time probing function.

In yet another case of the method, the probing function is a Fourier basis function and the continuous-time flux function is reconstructed from the amplitudes and phases of detected frequencies.

In yet another case of the method, the Fourier basis function is p_{ƒ}(t)=e^{-j2πƒt}.

In yet another case of the method, flux frequencies above ½q are ignored, where q is a given timing resolution.

In yet another case of the method, the method further comprising using a constant false alarm rate (CFAR) detector to identify and remove noisy frequencies based on a predetermined probability of false alarm.

In yet another case of the method, the predetermined probability of false alarm is determined by detecting whether a given probed frequency contributes to the flux function by determining if a corresponding amplitude is greater than a predetermined threshold.

In yet another case of the method, reconstructing the continuous-time flux function comprises summing, over the detected frequencies, corresponding Fourier basis functions scaled by their amplitudes and shifted by their associated phases.

In yet another case of the method, reconstructing the continuous-time flux function comprises determining [symbol] A_{ƒ} cos(2πƒt+φ_{ƒ}), where ƒ is the detected frequencies, [symbol] _{used} are the set of detected frequencies that are used, A_{ƒ} is the amplitude at each frequency, and φ_{ƒ} is the phase at each frequency.

In yet another case of the method, the reconstructed continuous-time flux function, or the integral thereof, is used for computer vision or image processing tasks.

In yet another case of the method, the absolute timestamp is a frame number within a sequence captured by an image sensor.

In another aspect, there is provided a system for single-photon imaging, the system comprising one or processors and a data storage, the data storage comprising instructions for the one or more processors to execute: an imaging module to receive, from a single photon detector, a plurality of asynchronous, or partially asynchronous, single-photon detections and an absolute timestamp associated with each one of the received single-photon detections; a probing module to perform probing measurements to determine a sum of values of a probing function on the single-photon detection values at each of the absolute timestamps; a reconstruction module to reconstruct a continuous-time flux function from the probing measurements; and an output module to output the reconstructed continuous-time flux function or an integral thereof.

In a particular case of the system, the probing function is performed on frequencies from 0 to a maximum recoverable frequency, where each of the frequencies are separated by a frequency step.

In another case of the system, the probing function is a continuous-time probing function.

In yet another case of the system, the probing function is a Fourier basis function and the continuous-time flux function is reconstructed from the amplitudes and phases of detected frequencies.

In yet another case of the system, the one or more processors further execute a noise module to implement a constant false alarm rate (CFAR) detector to identify and remove noisy frequencies based on a predetermined probability of false alarm.

In yet another case of the system, reconstructing the continuous-time flux function comprises summing, over the detected frequencies, the amplitudes and a cosine of the associated phases.

In yet another case of the system, reconstructing the continuous-time flux function comprises determining [symbol] A_{ƒ} cos(2πƒt+φ_{ƒ}), where ƒ is the detected frequencies, [symbol] _{used} are the set of detected frequencies that are used, A_{ƒ} are the amplitudes at each frequency, and φ_{ƒ} are the phases at each frequency.

In yet another case of the system, receiving the plurality of asynchronous single-photon detections from the single photon detector comprises performing scanning of a scene.

In yet another case of the system, the single photon detector comprises a one-dimensional or two-dimensional array of single-photon avalanche diodes.

In yet another case of the system, the reconstructed continuous-time flux function, or the integral thereof, is used for computer vision or image processing tasks.

In yet another case of the system, the absolute timestamp is a frame number within a sequence captured by an image sensor.

In another aspect, there is provided a processor-implemented method for single-photon imaging, the method comprising: receiving a plurality of asynchronous, or partially asynchronous, single-photon detections and an absolute timestamp associated with each one of the received single-photon detections; performing interval probing using a non-uniform fast Fourier transform to determine frequency content; determining interval bands with the frequency content determined using the non-uniform fast Fourier transform; performing probing measurements using only the identified interval bands to determine a sum of values of a probing function on the single-photon detection values at each of the absolute timestamps; reconstructing a continuous-time flux function from the probing measurements; and outputting the reconstructed continuous-time flux function or an integral thereof.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

A greater understanding of the embodiments will be had with reference to the Figures, in which:

FIG. 1A illustrates a setup for an example experiment for passive ultra-wideband sensing with a one-pixel single-photon detector;

FIG. 1B illustrates charts for reconstructed time-varying flux across various timescales for the example experiment for passive ultra-wideband sensing with a one-pixel single-photon detector;

FIG. 1C illustrates reconstructed video frames for the example experiment for passive ultra-wideband sensing with a one-pixel single-photon detector;

FIG. 1D illustrates the spectrum of the reconstructed flux function due to multiple concurrently-occurring phenomena in the example experiment for passive ultra-wideband sensing with a one-pixel single-photon detector;

FIG. 2 is a conceptual diagram illustrating a system for passive single-photon imaging, in accordance with an embodiment;

FIG. 3 illustrates a graph showing an example of a relation between a stream of absolute timestamps, a counting process, a flux function and its integral;

FIG. 4 is a conceptual flowchart illustrating a method for single-photon imaging, in accordance with an embodiment;

FIG. 5 are graphs illustrating an example approach of the method of FIG. 4 applied to photon timestamp data from a single pixel;

FIG. 6A are photographs illustrating simultaneous recovery of spinning fan and light propagation;

FIG. 6B is a photograph illustrating an experimental setup for two-dimensional ultra-broadband video acquisition;

FIG. 6C is a photograph illustrating an experimental setup for NLOS video imaging in a scene with multiple light sources;

FIGS. 6D and 6E are reconstructed video frames and charts illustrating flux functions visualized at two timescales, and for different points in a scene illuminated simultaneously by a pulsed laser and a flickering light bulb;

FIGS. 6F and 6G are photographs illustrating passive NLOS video acquisition using a raster-scanning laser projector and reconstructed video frames, along with the ground-truth frames;

FIGS. 6H and 6J illustrate a comparison of the system of FIG. 2 to the use of SPAD array data in accordance with another approach to reconstruct per-pixel flux; and

FIGS. 7A to 7C illustrate a comparison of imaging techniques, with photon timestamps, between approaches to passive imaging, approaches to active imaging, and the approach of the method of FIG. 4.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to photon processing and photonics, and more specifically, to a method and system for passive single-photon imaging.

Imaging highly dynamic scenes, both slow and ultra-fast, passively (i.e., without any light sources under control of the system, without synchronization, and without an abundance of light) is very challenging problem. This problem is particularly problematic for existing models for passive low-light imaging because they break down at timescales much shorter than the timespan between photon arrivals. As a result, ultra-fast imaging in low light has remained beyond the reach of current passive approaches.

The present embodiments advantageously bridge two regimes, active imaging and passive imaging. Specifically, in active single-photon imaging a periodic light-emitting source that is synchronized with the photon detector acquires photons and time-stamps their detection relative to the beginning of the most recent sync period. A passive single-photon imaging approach is provided herein that is specifically capable of eliminating synchronization between a camera and the light sources in a scene. In the present embodiments, each photon sensor (camera) pixel can time-stamp the photons it detects using an internal clock that follows the arrow of time, obviating the need for any external timing signals.

Passive (sync-free) imaging is advantageously more powerful than active imaging in low-flux settings. Specifically, without the periodic timing signal from a light source, time never wraps at a sync period. Ultra-fast scenes can be imaged for arbitrarily long timespans. Further, flux variations that occur concurrently across 12 orders of magnitude in time (picoseconds to seconds), and that involve many unknown sources, can be recorded with just one camera.

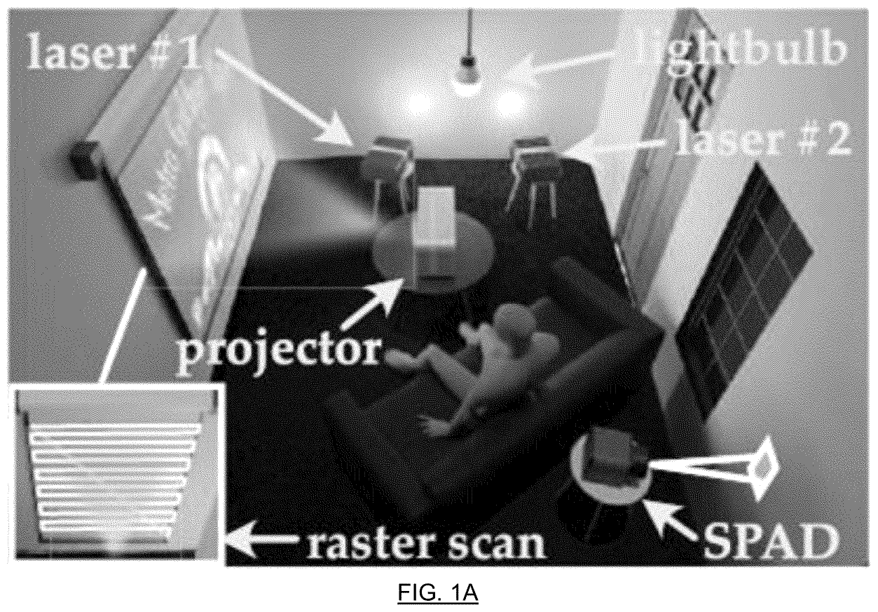

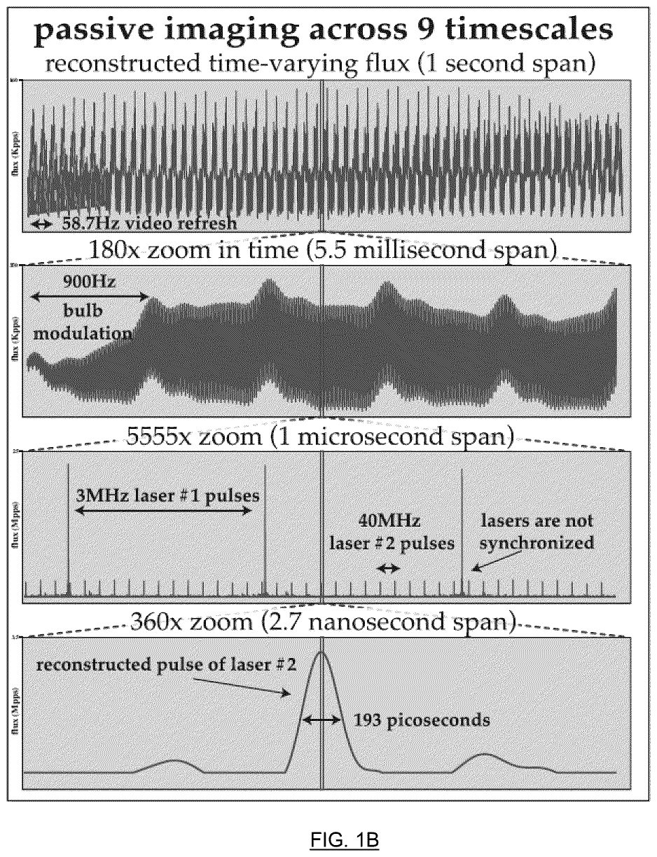

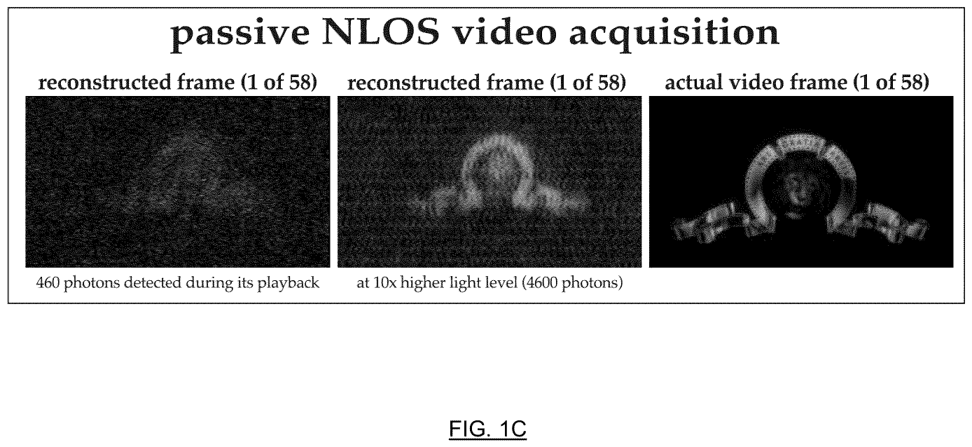

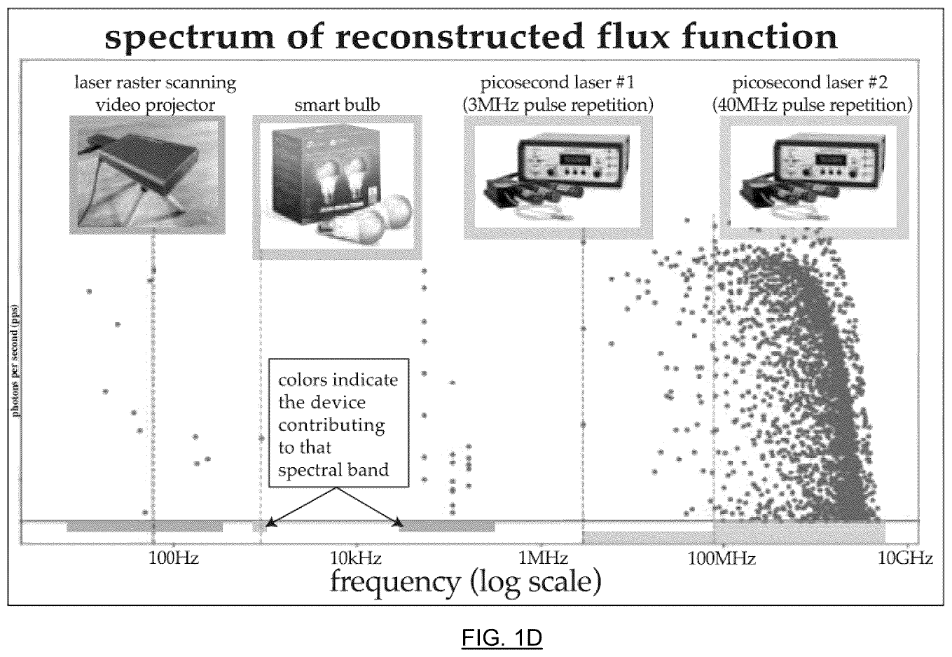

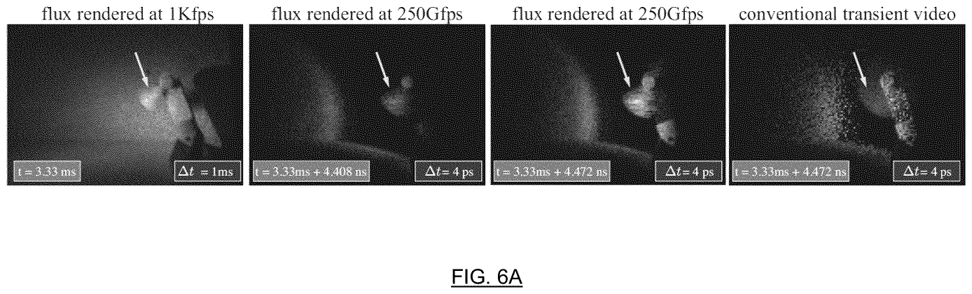

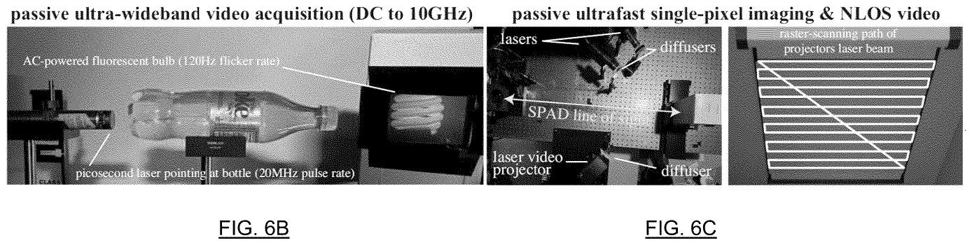

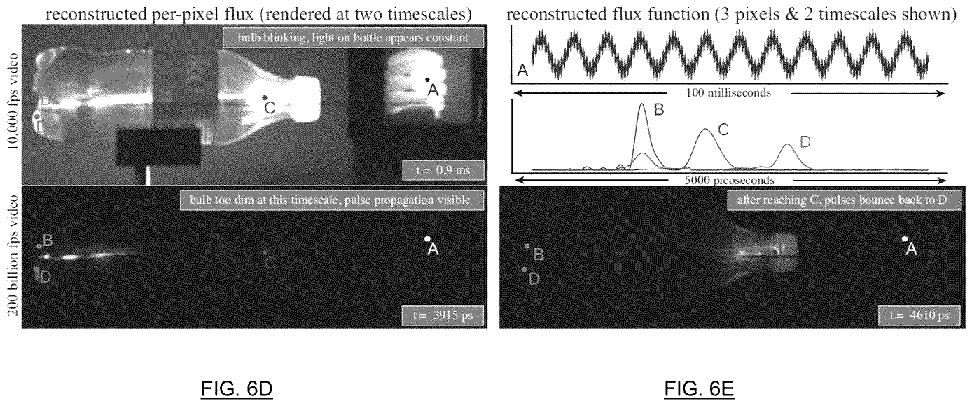

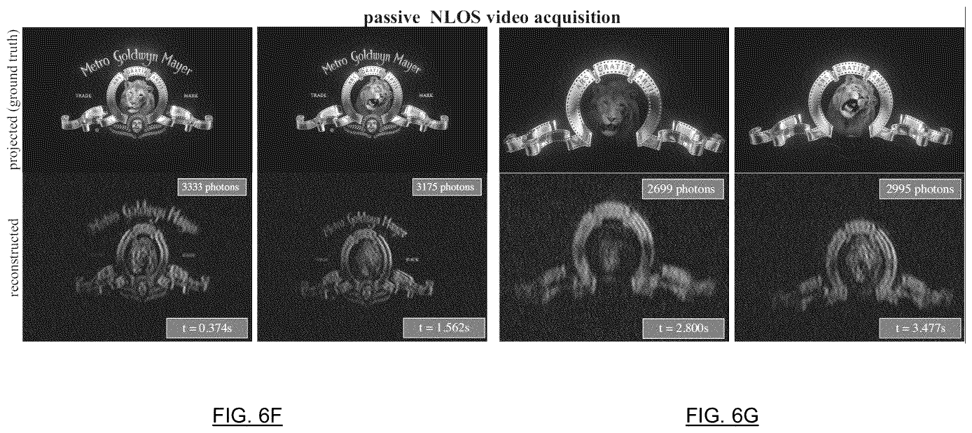

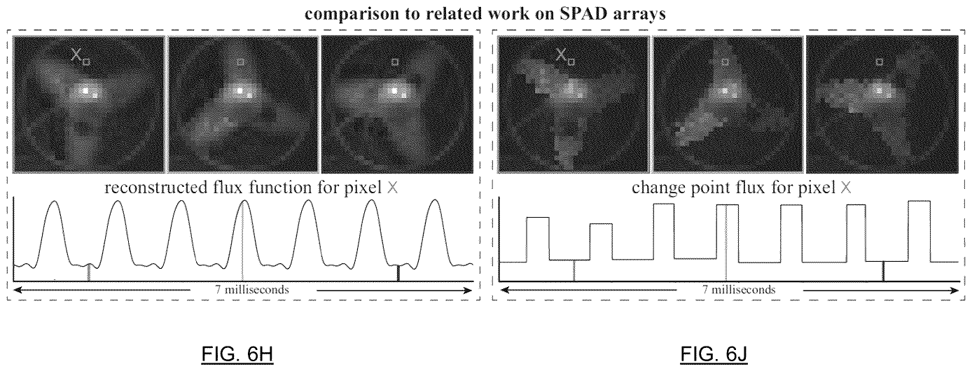

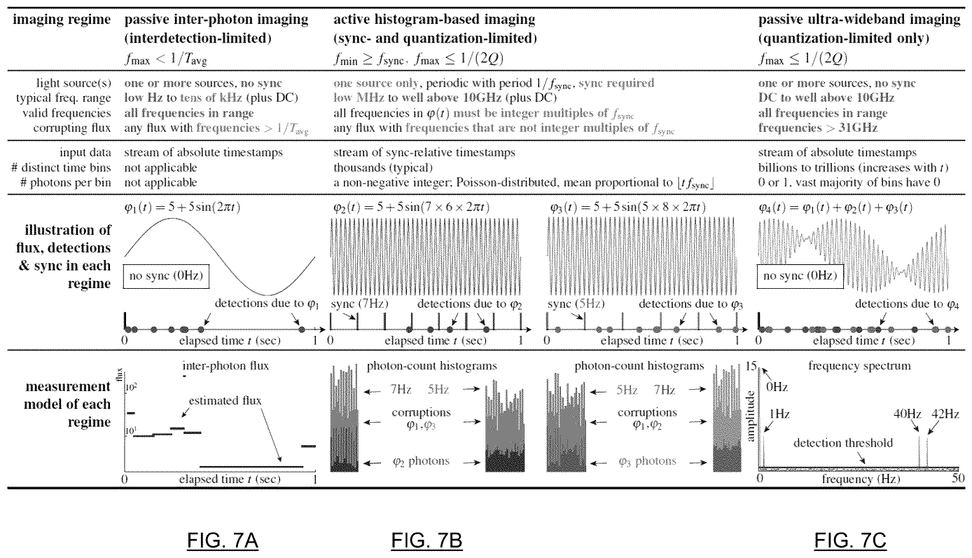

In embodiments of the present disclosure, because photon timestamps due to all light sources and all timescales can be recorded concurrently, the choice of which timescale to show and which light source(s) to use for visual processing can be advantageously performed after acquisition (as exemplified in FIGS. 1A to 1D, 6A, 6D and 6E). Thus, just like light field cameras enable post-capture refocusing in space, the present embodiments enable post-capture refocusing in time; from transient to everyday timescales. The approach of the present embodiments can be informally referred to passive ultra-wideband imaging.

Reconstructing flux functions with an ultra-wide spectrum (e.g., DC to 10 GHz) from a stream of asynchronous absolute photon timestamps is a substantial challenge. To address this challenge, the present embodiments use a flux probing approach, developed by the present inventors, which uses stochastic calculus to relate the Fourier series decomposition of a time-varying flux function to the timestamp realizations of an underlying stochastic process.

In passive settings, other techniques for estimating flux from photon data generally rely on a variety of flux constancy assumptions and, as a result, are not applicable to the ultra-wideband regime of the present embodiments. In active settings, other single-photon imaging techniques can process photons from only one light source and have generally relied exclusively on light source synchronization and sync-relative timestamps, where information about sub-MHz flux variations are lost. Aside from single-photon imaging, other techniques for active ultrafast imaging assume where only one synchronized source emits light and have generally relied on heterodyning to measure flux at one specific modulation frequency. In contrast to these techniques, the present embodiments have substantially improved light efficiency and ultra-wide bandwidth capabilities. Additionally, the present embodiments eliminate the need for light source synchronization, and can process photons from a plurality of artificial or natural light sources emitting light simultaneously.

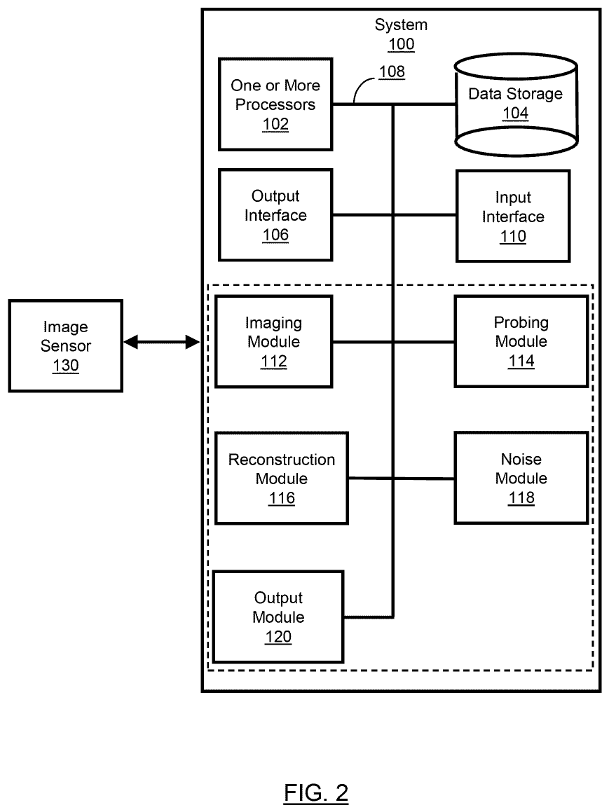

Referring now to FIG. 2, a system 100 for passive single-photon imaging, in accordance with an embodiment, is shown. As understood by a person skilled in the art, in some cases, some components of the system 100 can be executed on separate hardware implementations. In other cases, some components of the system 100 can be implemented on one or more general purpose processors that may be locally or remotely distributed, or processors/hardware on the image sensor itself.

FIG. 2 shows various physical and logical components of an embodiment of the system 100. As shown, the system 100 has a number of physical and logical components, including one or more processors 102, data storage 104, an output interface 106, and an input interface 110, and a local bus 108 enabling the components to communicate each other. The one or more processors 102 can include one or more central processing units, one or more graphical processing unit, microprocessors, dedicated hardware, logic arrays or other integrated processing circuits. The data storage 104 can store programs, instructions, and/or an operating system, including computer-executable instructions for implementing the methods described herein, as well as any derivative or related data. While FIG. 2 illustrates the system 100 implemented on a single computing device, it is understood that the processing, or any of the functions undertaken by the system 100, can be distributed over multiple computing devices; for example, in a cloud or distributed computing environment.

In an embodiment, the one or more processors 102 can be configured to execute a number of conceptual modules; for example, an imaging module 112, a probing module 114, a reconstruction module 116, a noise module 118, and an output module 120. In further cases, functions of the above modules can be combined or executed on other modules. In some cases, functions of the above modules can be executed on remote computing devices, such as centralized servers and cloud computing resources communicating over the network module 176.

The output interface 106 enables another electronic device or computing device to transmit data or receive the outputs from the system 100, as described herein. In some embodiments, the output interface 106 enables users to view such outputs, via for example, a display or monitor. In some cases, the outputs from the system 100 can also be stored in the data storage 104. In other cases, the outputs from the system 100 can undergo further processing by the system 100 or other devices; for example, for use in 3D imaging or passive extreme computer vision. The input interface 110, alone or in conjunction with the output interface 106 can communicate with certain devices, such as an image sensor 130, which can be internal or external to the system 100. The image sensor 130 can be any suitable device that can capture and store single photons and their associated arrival time; for example, an unsynchronized single-photon avalanche diode (SPAD) or a one-dimensional or two-dimensional array of SPADs.

In the present embodiments, the system 100 can be used in both situations where the system 100 exerts control over a scene's appearance and situations where the system exerts no control over a scene's appearance. In this way, the scene's light source(s) can be natural, artificial or both, and their number, operating principle, and time-varying properties can be unknown and unconstrained. It can also be assumed that no electronic timing signals, such as triggers or sync pulses, are received.

Following standard radiometric conventions, incident light at a pixel can be expressed as an unknown time-varying function φ(t) that represents the pixel's instantaneous flux at time t≥0. A goal is to acquire a continuous representation of the flux function over a possibly unbounded acquisition interval [0, t] (milliseconds, seconds or much longer). In the present disclosure, it can be assumed that φ(t) is continuous and has finite spectral support, bounded by frequencies ƒₘᵢₙ and ƒₘₐₓ.

The system 100 can seek to reconstruct flux functions that have ultra-wide bandwidth, for example, whose frequency content spans the entire range from constant flux (ƒₘᵢₙ=0 Hz) to extreme time-of-flight timescales (ƒₘₐₓ≥10 GHz). Moreover, it can be assumed that no prior information is available about the spectrum of φ(t).

The system 100 can be applied to single-photon imaging, where the timespan between consecutive photon arrivals is not negligible. In this setting, φ(t) is the rate function of an inhomogeneous Poisson process governing photon arrivals. The mean value of φ(t) represents the average flux received over the observation interval [0, t] in units of photons per second and its inverse, denoted by t_{avg}, is the average timespan between consecutive photon arrivals.

SPADs can generally detect and timestamp the arrival of individual photons with extremely high temporal precision (typically tens of picoseconds). SPADs can, however, exhibit four main non-idealities: quantum efficiency, dead time, timestamp quantization and jitter. Quantum efficiency refers to the pixel's probability of actually detecting a photon when it is in its active state. This probability can be well below 1 depending on wavelength; since it can be thought of as scaling the flux function, it can be assumed that it is absorbed in φ(t). After a photon detection, SPADs are blind to subsequent photon arrivals for an interval known as the dead time. Dead time can skew photon detection statistics quite significantly in “high-flux” settings, when photons arrive closely enough in time to fall within a SPAD's dead-time window with high probability. The present disclosure generally focuses on low-flux imaging, where consecutive photon arrivals are spaced farther apart than the SPAD's dead time. For example, t_{avg} was fifteen times greater in an example SPAD's dead time in example experiments (3.8 microseconds versus 250 nanoseconds). In this case, photon detections are governed by the same stochastic process that describes photon arrivals, with rate function φ(t) and average timespan t_{avg} between detections. However, in further cases, the system 100 can be used in any suitable case of non-negligible dead time.

Photon timestamps are subject to quantization from the time-to-digital conversion process and jitter, i.e., instabilities in timing electronics. Both can be as low as a few picoseconds for SPADs in the visible range. In general, it can be assumed that timestamp resolution and timestamp accuracy are identical, so that the timestamps' bin size q accounts for jitter as well. When timestamp accuracy is lower than timestamp resolution, the timestamps' effective number of bits is reduced. The system 100 can use timestamps, for example, that are quantized to 4 picoseconds but the standard deviation of jitter is 16 picoseconds; so, conservatively, q=16 can be used for performance modeling.

Since no external timing signal is available to serve as a reference, it can be assumed that photon detection timestamps follow the arrow of time, increasing monotonically according to the SPAD's internal clock. This results in a stream of timestamps [symbol] =(τ₁, . . . , τₙ₍ₜ₎, where τᵢ is the elapsed time from the beginning of acquisition until the i-th photon detection, and n(t) counts the total photons detected up to time t. Timestamps τᵢ are referred to as absolute timestamps. Absolute timestamps can be acquired by operating SPAD pixels in a “passive free-running” mode. In further cases, the absolute photon timestamp can be a frame number within a sequence captured by an image sensor, such as a Quanta image sensor.

Other approaches to passive low-flux imaging with SPADs generally treat the timespan between consecutive detections as a noisy sample of the scene's flux. This implicitly assumes that flux does not vary in that timespan, which makes the rate of photon detections a (loose) upper bound on ƒₘₐₓ. As a result, these approaches have been restricted to slow speeds, with ƒₘₐₓ on the order of tens of kHz.

Approaches that employ synchronized light sources have generally occupied the other extreme of the frequency range. Their basic principle is to time-stamp detections relative to a sync signal of a known frequency ƒ_{sync}, so that all timestamps wrap to the same brief interval [0,1/ƒ_{sync}] regardless of the actual timespan between them. This forces photons to accumulate in a relatively small number of time bins, typically a few thousand, and yields a photon-count histogram that is a noisy sampling of a scaled and time-wrapped flux function, [tƒ_{sync}]φ(t−[tƒ_{sync}]/ƒ_{sync}); i.e., the flux function can wrap or fold on itself for time values exceeding the duration of the sync period. The maximum re-constructible frequency in this case is governed by the Nyquist theorem, not the photon inter-detection time; for example, a bin size of 16 picoseconds theoretically enables flux acquisition with ƒₘₐₓ equal to 31.25 GHz.

Although these photon-histogramming approaches can achieve extremely high imaging speeds, their reliance on relative timestamps comes with a substantial constraint being that the incident flux must also be a periodic function with a period equal to ƒ_{sync} to ensure that φ(t) and its time-wrapped counterpart are identical. This can be trivially satisfied when the only light in the scene comes from a precisely-synchronized source (a pulsed laser, light-emitting diode, etc.), but flux variations due to other causes cannot be reconstructed. This includes variations caused by scene motion, caused by light sources that emit at frequencies lower than ƒ_{sync}, and caused by sources that emit at higher frequencies that are not integer multiples of ƒ_{sync}. Photons from such sources result in histogram artifacts in the form of additional photon noise, beat signals, or both.

The sync signals employed by these approaches are typically in the low-MHz range in single-photon imaging applications that involve pulsed sources. This choice balances improved signal to noise ratio (a faster sync means more laser pulses, more photons detected in each histogram bin, and fewer time bins for them to accumulate in) against the likelihood of photons being missed due to dead time, or photons arriving “too late” because time has wrapped already. At such MHz sync frequencies, the memory and computational cost of reconstructing histograms from timestamps can be significant, prompting several schemes for just-in-time processing of (sync-relative) photon timestamps.

Advantageously, the system 100 considers the relation between a rate of photon detections and a maximum reconstructible frequency. Also advantageously, the system 100 can be considered as the limit case of photon histogramming, where the sync signal's frequency is reduced all the way to zero. Specifically, as ƒ_{sync} decreases, the interval [0,1/ƒ_{sync}] increases and more histogram bins are needed to span it. Additionally, fewer photons land into each bin. Further, a time-wrapped flux function is able to represent variations that take place over longer timespans. Furthermore, a space of re-constructible frequencies (e.g., the integer multiples of ƒ_{sync}) expands. In the limit when ƒ_{sync} is exactly zero, there is generally no sync at all, and timestamps become absolute as every photon lands into its own unique time bin. Crucially, all frequencies from direct current (DC) up to the Nyquist limit, and from any light source, can become potentially re-constructible.

Mathematical modeling of the limit case is non-trivial because the concept of a histogram breaks down because photons never accumulate, and the contents, 0 or 1, of any given bin provide almost no information about the flux function. On the computational side, the entire acquisition interval [0, t] is effectively partitioned into time bins at the SPAD's timing resolution, so acquisitions of a second or more can potentially involve trillions of time bins (most of which are empty). Fortunately, the present inventors determined that both these challenges can be overcome by formulating flux reconstruction in terms of the photon counting process, which is not degenerate even when ƒ_{sync}=0.

The system 100 establishes a direct mathematical link between a stream of absolute timestamps detected at a pixel, however few or far apart they may be, and a flux function that produced them. This link allows the system 100 to “probe” the Fourier spectrum of an unknown flux function across, for example, the entire DC-to-GHz range for frequencies that have statistically-significant support in the timestamp data. A flux probing approach is provided to address flux reconstruction. For the sake of generality, timestamps can be considered to be continuous-valued random variables whose quantization can be incorporated.

For photon counting, even though a single absolute timestamp provides (almost) no information about the underlying flux function, the stream of absolute timestamps as a whole contains considerable usable information. The present inventors have determined that a specific relation between the two can be determined using stochastic calculus. Specifically, in the continuous-time domain, a stream [symbol] of real-valued absolute timestamps provides a noisy “reconstruction” of the integral of φ(t):

$${\underbrace{n ( t )}}_{counting process} = {\underbrace{{\int }_{0}^{t} φ ( u ) du}}_{fluc integral up to time t} + {\underbrace{m ( t )}}_{martingale noise} \qquad ( 1 )$$

The function n(t) in Equation (1) counts the photons received up to time t and is completely determined by [symbol] ; formally, it is a counting process. Viewed from the perspective of histogram-based single-photon imaging, n(t) is the continuous-time analog of the cumulative photon-count histogram over the interval [0, t], for ƒ_{sync}=0. The function m(t) in Equation (1) is a continuous-time random process called a martingale that can be thought of as a form of additive zero-mean noise.

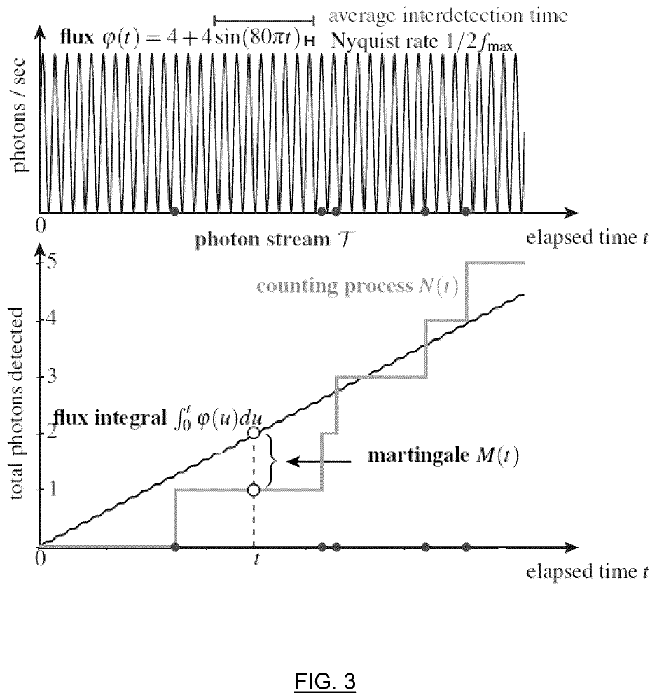

FIG. 3 illustrates a graph showing an example of a relation between the stream of absolute timestamps, the counting process, the flux function and its integral. Timestamps in this example are from a computational simulation of the inhomogeneous Poisson process with the flux function φ(t) described herein. As can be seen from the example of FIG. 3, a single random realization of the counting process is a highly discontinuous function that, on first inspection, bears no resemblance to the flux integral it is supposed to approximate in Equation (1). These discontinuities introduce dense, spurious frequencies in the Fourier-domain representation of n(t) that do not exist in the actual flux integral.

The system 100 generally uses tools from stochastic calculus to address, at least:
What is the highest possible frequency ƒₘₐₓ that can be recovered by a passive single-photon imaging system that outputs quantized absolute timestamps?
For frequencies within the attainable bandwidth, how can a noise model be derived that allows spurious frequencies to be efficiently detected and discarded, and the accuracy of real frequencies to be quantified as a function of the acquired timestamp stream?

A first proposition is that the system 100 can always probe the flux function to recover a (noisy) measurement of its inner product with almost any other function. Moreover, probing is efficient to compute from the timestamp stream and can be thought of as a continuous-time and sync-free generalization of compressive acquisition schemes for photon-counting histograms. In particular, let t be the stream of real-valued absolute timestamps up to time t and let p(t) be a probing function. In most cases, the probing function p(t) is a continuous-time probing function. In most cases, the probing function p(t) is also an arbitrary known and square-integrable function. The inner product of the probing function p(t) and the unknown flux function φ(t) over the time interval [0, t] satisfies the relation:

$$p ( 𝓉 ) = 〈 p , φ 〉 + {m}_{p} ( t ) \qquad ( 2 )$$

where p( [symbol] ) are “probing measurements” which sum the values of the probing function at the absolute timestamps:

$${p ( 𝓉 )}^{def} = {\sum }_{τ ∈ 𝓉} p ( τ ) \qquad ( 3 )$$

where mₚ(t) is a martingale, and the inner product is

$${\int }_{0}^{t} p ( u ) φ ( u ) d u .$$

Equation (2) is derived from Equation (1) using stochastic calculus; informally, it involves differentiating both sides of Equation (1), and applying the probing function to the result on both sides as well. Equation (3) informally “weights” the integral of the timestamps by the probing function, and using stochastic calculus, provides a noisy approximation of the inner product of the flux function with the probing function.

In the special case of probing with the Fourier basis functions p_{ƒ}(t)=e^{-j2πƒt}, probing with ƒ>½q yields aliased measurements that “wrap around” the frequency spectrum and are identical to, and indistinguishable from, lower-frequency measurements.

Accordingly, Equation (1) establishes a relation between the derivatives of the counting process n(t) and the right-hand side of Equation (1). This relation is used to arrive at Equation (2) from Equation (1), which provides the described probing. Informally, the derivative of n(t) is zero except at time instants when a photon arrives, where it is equal to one; i.e., n(t) is used to counts photon, and as such, it increases by 1 when a photon arrives and remains constant otherwise. So the integral of the probing function p( ) is equal to the sum of the values of p( ) at the photon arrival timestamps; which is represented by the left-hand side of Equation (2).

A second proposition is that given timing resolution q, the maximum recoverable frequency is

$${f}_{max} = \frac{1}{2 q} .$$

Intuitively, the second proposition says that flux frequencies above ½q are unrecoverable regardless of whether the system 100 detects, for example, a few photons or a million photons. Thus, ƒₘₐₓ represents the highest possible frequency that can be recovered by a passive single-photon imaging system that outputs quantized absolute timestamps.

The system 100 can use a noise model to account for the inhomogeneous Poisson nature of photon detections and treat the general case of real-valued timestamps. The noise model is usable for arbitrary flux levels within the low-flux regime and remains valid for low-count acquisitions (e.g., as few as ten photons). More specifically, a third proposition, below, indicates that the noise in probing measurements has a distribution that can be estimated from the timestamp stream through another probing operation. Thus, probing gives the means both to observe a flux function and to quantify the uncertainty of that observation.

The third proposition is that the probing measurements p( [symbol] ) are approximately normally distributed with mean [symbol] p,φ [symbol] and variance [symbol] p²,φ [symbol] .

The following corollaries allow the system 100 to quantify the accuracy by which specific flux frequencies can be estimated from a given timestamp stream.

In a first corollary, Fourier probing measurements p_{ƒ}( [symbol] ) are approximately complex normal distributed with mean and covariance matrix, determined respectively as:

$$μ = [ 〈 cos ( 2 π ft ) , φ ( t ) 〉 〈 - sin ( 2 π ft ) , φ ( t ) 〉 ] \qquad ( 4 )$$

$$\sum = [ \begin{matrix}〈 {cos}^{2} ( 2 π ft ) , φ ( t ) 〉 & 0 \\ 0 & 〈 {sin}^{2} ( 2 π ft ) , φ ( t ) 〉\end{matrix} ] \qquad ( 5 )$$

In a second corollary, a normalized energy of the Fourier basis probing measurements can be determined as:

$${p}_{f}^{e} ( t ) {=}^{def} {Re [ \frac{{p}_{f} ( t )}{\sqrt{{\sum }_{1 , 1}}} ]}^{2} + {Im [ \frac{{p}_{f} ( t )}{\sqrt{{\sum }_{2 , 2}}} ]}^{2} \qquad ( 6 )$$

follows a non-central χ² distribution with 2 degrees of freedom and non-centrality parameter

$${μ}_{1}^{2} / {\sum }_{1 , 1} + {μ}_{2}^{2} / {\sum }_{2 , 2} .$$

The present inventors have determined that unbiased estimators of the parameters of the above distributions can be obtained via probing.

Given the estimated distribution of the Fourier Probing Energy, a constant false alarm rate (CFAR) detector can be used to identify and remove noisy frequencies based on a desired probability of false alarm α. False alarms occur when the system keeps ƒ and E[|p_{ƒ}( [symbol] )|]=0; where ƒ can be removed if

$${p}_{f}^{e}$$

( [symbol] ) is lower than

$${CDF}_{{χ}^{2}}^{- 1} ( 1 - α ) ,$$

derived from the second corollary. Specifically, the system 100 detects frequencies for which:

$${\vert {p}_{f} ( t ) \vert}^{2} \geq {CDF}_{{χ}^{2}}^{- 1} ( 1 - α ) \frac{n ( t )}{2 {t}^{2}} \qquad ( 7 )$$

Equation (7) is thus, for frequencies within the attainable bandwidth, a noise model that allows spurious frequencies to be efficiently detected and discarded, and the accuracy of real frequencies to be quantified as a function of the acquired timestamp stream.

For a fixed α, the probability of detecting a frequency is proportional to the total number of photons detected; and, for flux functions dominated by a particular frequency such that |p_{ƒ}_{ᵢ}( [symbol] )|² is large, n(t) also tends to become proportionally larger, reducing the probability of detecting other frequencies.

The second proposition indicates that, rather than being a hindrance, sync-less imaging with absolute timestamps confers an extreme bandwidth advantage to single-photon sensor systems. For example, with a 16-picosecond resolution, the system 100 can simultaneously acquire flux variations that span the entire DC-to-31 GHz range of frequencies, and that are due to any number of unknown light sources operating independently. This bandwidth is orders of magnitude broader than intensity cameras, SPADs or otherwise, were generally thought capable of acquiring directly without resorting to homodyne or heterodyne detection schemes.

While the second proposition describes re-constructability (e.g., frequencies above the limit are unreconstructible), the third proposition and Equation (7) provides insights about the accuracy and detectability of flux variations at different frequencies.

Example experiments conducted by the present inventors show several real-world demonstrations of simultaneous DC-to-10 GHz imaging under very challenging lighting conditions. These experiments validate the noise models in Equations (4) to (6) and at least partially confirm a theoretical bound.

The probing approach described herein provides an ability to reconstruct a Fourier transform of the flux function by frequency-scanning the entire DC-to-GHz bandwidth. This approach differs from other approaches, such as the Fourier-Domain Histogramming technique, because it provides a principled way to estimate frequency uncertainty in an acquired timestamp stream, it applies to streams consisting of absolute photon timestamps acquired without any synchronization, and it enables tractable operation in a regime involving potentially billions of candidate frequencies (e.g., a 1 Hz-resolution scan of DC-to-10 GHz) by rejecting spurious frequencies and reducing storage requirements. The frequency detection can include flux probing where a is set, for example, so that the expected number of false alarms is less than 1. While the present disclosure generally describes reconstructing the flux function from the Fourier transform, it is understood that any suitable reconstruction technique can be used; for example, least-squares, training a neural network to represent the flux function, or the like.

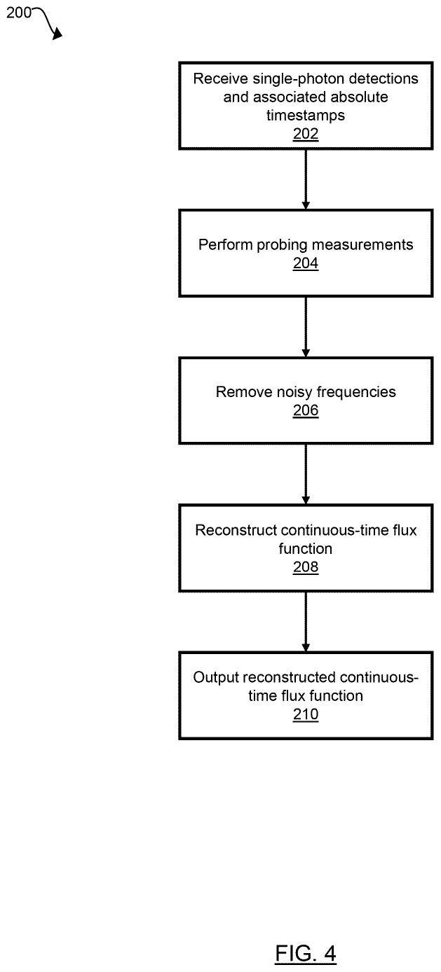

FIG. 4 illustrates a flowchart of a method 200 for single-photon imaging, in accordance with an embodiment. In some cases, the method can be used for passive imaging. However, in other cases, the method can be performed with active imaging; for example, the environment may be illuminated by actively controlled sources, such as lasers and the like. In both imaging scenarios, there is no requirement that light source(s) are to be synchronized with the image sensor 130. Additionally, the method 200 can be performed in the presence of a plurality of light sources; including natural sources or artificial sources such as lasers, projectors, and the like.

At block 202, the imaging module 112 receives a plurality of asynchronous, or partially asynchronous, single-photon detections from the image sensor 130 capturing a scene. The imaging module 112 also receives absolute timestamps associated with each one of the received single-photon signals. The plurality of asynchronous single-photon detections can be received by the single photon image sensor 130 from a scanning of the scene, or can be received by a one-dimensional or two-dimensional array of single photon detectors as the image sensor 130, or an array of image sensors 130, with or without scanning. In a particular case, the single photon image sensor(s) 130 can be single photon avalanche diode (SPAD) sensor(s).

‘Asynchronous’ is understood to mean that the image sensor 130 and the system 100 operate without synchronization with the light source(s). ‘Partially-asynchronous’ is understood to mean an operation of the system 100 between fully-asynchronous and fully-synchronous; such as between a fully-asynchronous mode and a frame-based mode. In an example of partially-asynchronous operation, some 2D SPAD sensors output a 2D ‘frame’ of timestamps at rates of 50,000 to 500,000 frames per second, where each frame records at most one photon timestamp per pixel. In another example of partially-asynchronous operation, some cameras output a sequence of binary frames, with each bit indicating whether or not a photon was detected at a particular pixel during the frame's exposure time. In such case, the photon detections could be considered synchronous across the image sensor but may not be synchronized with an external light source; and thus, partially-asynchronous.

‘Absolute’ is understood to mean that time is measured against a clock that can be internal or external to the system 100 and/or the image sensor 130. Absolute is with respect to elapsed time from the start of acquisition of the single-photon signals, a universal time, or other fixed time point. In this way, ‘absolute’ is understood to mean that elapsed time is measured relative to a fixed point in time and not measured as an offset from a periodic timing signal (for example, relative to the beginning of a pulse from a laser, relative to the rising or falling edge of a square wave, or the like).

At block 204, the probing module 114 performs probing measurements to determine a sum of the single-photon detection values of a probing function at each of the absolute timestamps. In most cases, the probing function p(t) is a continuous-time probing function. The use of a continuous-time probing function provides substantial advantages over, for example, the use of discrete vectors due to the substantial increase in accuracy for the resulting determinations outputted by the system 100.

At block 206, in some cases, the noise module 118 identifies and removes noisy frequencies based on a predetermined probability of false alarm and removes such frequencies. In a particular case, the noise module 118 can implement a constant false alarm rate (CFAR) detector; however, any other suitable detection scheme can be used that identifies statistically significant frequencies

At block 208, the reconstruction module 116 reconstructs a continuous-time flux function from the amplitudes and phases of detected frequencies in the probing measurements.

At block 210, the output module 122 outputs the reconstructed continuous-time flux function, or an integral thereof, to data storage 104 or the output interface 106, or both. The reconstructed continuous-time flux function, or its integral, can be used, or can be used as a combination with other single-photon sensors (each representing a pixel), for a number of applications; for example, video with widely varying speeds, passive three-dimensional sensing or imaging, computer vision on different timescales, scientific imaging (for example, used with telescopes to measure pulsars and other ultra fast signals); biological imaging of ultra-fast structures, navigation under low light, among many others.

In some cases, the output module 122 can decompose the reconstructed continuous-time flux function into a plurality of component flux functions, for example, one per individual light source; as described with reference to FIGS. 1B, 1C, and 1D. In some cases, the system 100 can perform further computational processing on the reconstructed continuous-time flux function; for example, for use in 3D imaging, laser analysis, optical visual communication, or the like.

In an example, the system 100 can perform the method 200 using the following pseudocode approach:

```
procedure fluxrec ( [symbol]   , t, fₘₐₓ, α)
  // Frequency scanning.
  Δf = 0.6/t [symbol]
  = freqs from 0 to fₘₐₓ with step Δf
  loop f ∈ [symbol]
    p_{f}( [symbol]   ) = (1/t) [symbol]   e^{-j2πfτ}
  // Frequency detection. [symbol]
  _{used} = Ø
    f ∈ [symbol]
    A_{f} = |p_{f}( [symbol]   )|, φ_{f} = ∠p_{f}( [symbol]   )
    reject f using Equation (7) [symbol]
    _{used} = [symbol]   _{used} ∪ {f} if not rejected
  // Flux reconstruction.
  \hat{φ}(t) = [symbol]   A_{f}cos(2πft + φ_{f})
```

In the above, the frequency step Δƒ can be pre-determined or determined adaptively.

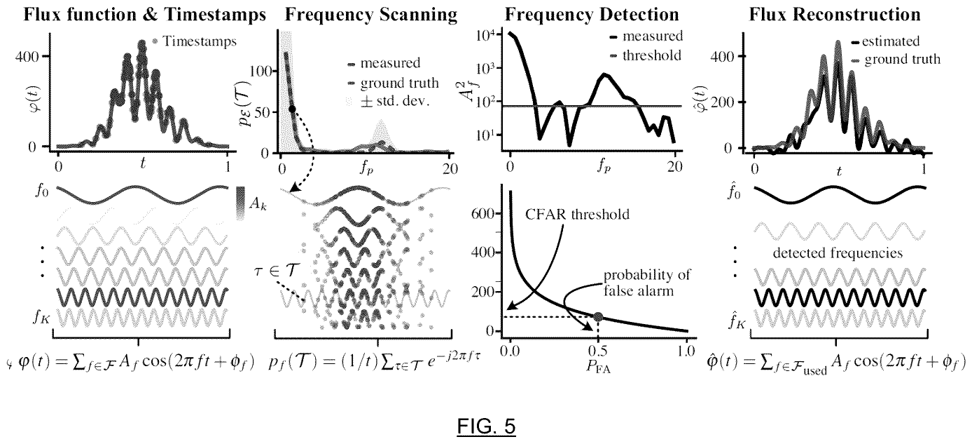

FIG. 5 shows a visual illustration of the above pseudocode. The flux function, of finite spectral support, can be expressed as a sum of sinusoids and produces a stream of absolute timestamps. The frequency scanning can be used to probe the flux function, using a Fourier basis, and measure the response at each frequency. Frequency detection can be performed by detecting, for each of the probed frequencies, whether it contributes to the flux function if its corresponding amplitude is greater than a threshold (top graph), which is selected to achieve the desired probability of false alarm (bottom graph). The flux reconstruction can be used to reconstruct a continuous-time flux function from the amplitudes and phases of the detected frequencies. In some cases, the reconstruction module 116 can identify one or more dominant frequencies in the set of detected frequencies and add higher harmonics of the dominant frequencies to the set of detected frequencies that are used.

The present inventors validated the substantial advantages of the present embodiments with example experiments for passive ultra-wideband imaging. Including using passive ultra-wideband sensing for both 1D intensity signals and 2D video signals ranging from DC to 10 GHz, passive non-line-of-sight (NLOS) video via MHz-rate flux function reconstruction, and generalization to 2D SPAD arrays for high speed video imaging.

For passive ultra-wideband sensing, the example experiments recovered signals across frequency scales spanning roughly 9 orders of magnitude from DC to 5 GHz; as illustrated in FIGS. 1A to 1D. A single-pixel SPAD was placed in a scene to capture flux variations from (1) pulse-width modulation of a light bulb (900 Hz), (2) backscattered light from a raster-scanning laser projector (60 Hz-10 MHz), and (3) two unsynchronized picosecond lasers (40 MHz-10 GHz). Remarkably, the flux function is reconstructed from only 77,000 photon timestamps. The system 100 recovered time-varying flux across billions of frequencies from this minuscule set of photons.

FIGS. 1A to 1D illustrate experimental results for passive ultra-wideband imaging with a single free-running SPAD pixel. As shown in FIGS. 1A and 1B, in a real, captured experiment, an unsynchronized single-photon avalanche diode (SPAD) passively records indirect light coming from multiple sources operating asynchronously from each other (unsynchronized picosecond lasers, projectors, etc.). The incident flux exhibits simultaneous intensity variations with a bandwidth that spans roughly 9 orders of magnitude in frequency. As shown in FIG. 1D, multiple concurrently-occurring phenomena in the flux function can be identified after acquisition: video flicker (58 Hz), the pulse-width modulation of an LED light bulb (900 Hz), a movie projected onto a nearby wall by a raster-scanning laser projector (up to 5 MHz), and two unsynchronized picosecond lasers (40 MHz-10 GHz). As illustrated in FIG. 1C, by reconstructing the time-varying flux function of the laser projector, video frames are reconstructed at 1280×720 resolution using roughly 450-4500 photons collected during each 1/58 of a second frame.

FIGS. 6A to 6J illustrate examples of passive ultra-wideband imaging experiments conducted by the present inventors. FIG. 6A illustrates simultaneous recovery of spinning fan and light propagation. Rendering the flux function at 1 Kfps reveals motion of the fan (shown by the arrow), but light propagation is invisible. At 250 Gfps light propagation is visible, and the fan freezes. Conventional histogramming (right) synced to the laser fails to recover the (unsynced) fan rotation. FIGS. 6B and 6C illustrate an experimental setup for ultra-broadband video acquisition (FIG. 6B) and NLOS video imaging in a scene with multiple light sources (FIG. 6C). FIGS. 6D and 6E illustrate flux function images at two timescales and for different points in the scene illuminated by a pulsed laser and flickering light bulb. The three peaks at B, C, and D correspond to a light pulse entering the bottle (B) propagating to the cap (C), and reflecting back (D). FIGS. 6F and 6G illustrate passive NLOS acquisition using a raster-scanning laser projector with ground truth and reconstructed frames. FIGS. 6H and 6J illustrate a comparison of the present system 100 to the use of SPAD array data in accordance with another approach to reconstruct per-pixel flux. In the other approach, piecewise constant flux does not hold even for this simple scene of a rotating fan.

The example experiments demonstrated ultra-wideband video (as illustrated in FIG. 6A) is performable by raster scanning a scene in which a pulsed laser, with 20 MHz repetition and 80 ps full width at half maximum (FWHM), is diffused to illuminate a fan spinning at 108 Hz. The system 100 detected frequencies from DC to 10 GHz and rendered flux functions at 1 Kfps and 250 Gfps, showing both the fan blades rotating and the propagation of the laser pulse. In contrast, other approaches reconstruct the scene at only one of the aforementioned framerates, temporally blurring either slow or fast events. Furthermore, the system 100 can render the flux at any suitable timescale, essentially freezing time at all timescales. In this experiment, because only a single pixel SPAD was used, the timestamps were collected by scanning across the field of view of the SPAD. In other cases, a two-dimensional array of SPAD sensors can be used, in which case, scanning is not required. No synchronization signals were used to reconstruct the flux functions; thus, the example experiments demonstrate the substantial advantage of reconstructing the appearance of the scene as it appeared during each laser pulse. This is distinct from the use of synchronization and histogramming to estimate the average appearance of the flux function over time. The images in the example experiments were rendered by integrating the flux function over the exposure of each frame. As such, these images exhibit not only high dynamic range but their intensities are also expressed in physical units of photons, thereby ensuring radiometric calibration by nature.

FIG. 6B illustrates another video example where the same picosecond laser illuminates a Coca-Cola bottle filled with water and a small amount of milk to scatter the light. Within the same scene, a compact fluorescent lightbulb (CFL) flickers at 120 Hz. The system 100 rendered videos at 10 Kfps and 200 Gfps to visualize the CFL flicker and light pulses propagating through the bottle, as illustrated in FIGS. 6D and 6E.

In the example experiments, the system 100 performed passive non-line-of-sight (NLOS) video reconstruction using light measured indirectly from a raster-scanning laser projector (see illustration and photo in FIGS. 1A to 1D and FIG. 6C). During the raster scan of the projector, the SPAD collects indirect light from the projector by observing a single point on a wall. By reconstructing the 1D flux function of the raster scan, a video is recovered. Results of the example experiments demonstrate that for both the multi-illumination setting in FIGS. 1A to 1D and single projector setting. In the latter case, the system 100 recovered fine details (illustrated in FIGS. 6F to 6H) from only 3000 photons collected during the 1/60 second raster scan of each video frame.

The example experiments also demonstrated that the system 100 can be applied off-the-shelf to various SPAD sensors. The example experiments compared the approach undertaken by the system 100 to another approach that recovers high speed video using a 32×32 SPAD array, and that assumes piecewise constancy of the flux to identify contiguous sets of timestamps with the same flux. The other approach averages each set of timestamps to recover a single estimate of the flux (illustrated in FIG. 6J). In contrast, the system 100 recovered a time-varying flux function using flux probing (illustrated in FIG. 6H). The system 100 advantageously recovered a time-varying flux function that is truer to the periodic motion of a rotating fan.

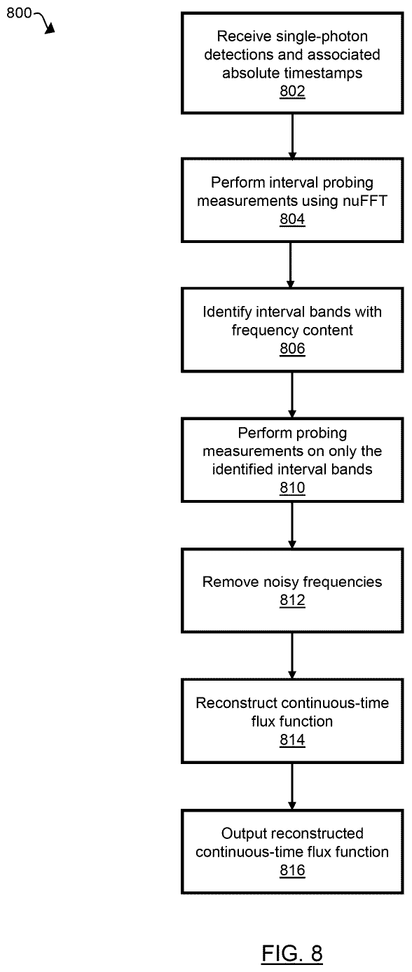

FIGS. 7A to 7C illustrate a comparison of low-flux imaging techniques, with photon timestamps, in accordance with the example experiments. FIG. 7A shows other approaches to passive imaging generally assumes that photons can be detected at a rate (much) greater than the highest flux frequency. FIG. 7B shows that active techniques are designed to handle the opposite case, where photon detections occur at a rate (much) lower than the flux function's frequencies. If a light source's frequency is not a multiple of ƒ_{sync} (e.g., 5 Hz for 42 photons and Hz for (3 photons), its photons will land in the wrong time bin. This contributes to noise instead of signal, i.e., their histograms will be “flattened” (compare the histograms in the third row). Moreover, even when ƒ_{sync} is well-matched to a light source, sources emitting at non-multiples of ƒ_{sync} will corrupt the histogram (shown in histograms). FIG. 7C shows the approach of the present embodiments where the system 100 advantageously inherits the most important features of both these regimes, without their limitations.

The present embodiments addressed the substantial problem of imaging a dynamic scene over an extreme range of timescales simultaneously (e.g., seconds to picoseconds) and doing so passively, without much light, and without any timing signals from the light source(s) emitting it. Because other flux estimation techniques for single-photon cameras break down in this regime, embodiments of the present disclosure use a flux probing technique to enable reconstruction of a pixel's time-varying flux from a stream of monotonically-increasing photon detection timestamps. This technique was used to (1) use passive free-running SPAD cameras with a frequency bandwidth that spans the entire DC-to-31 GHz range in low-flux conditions, (2) perform Fourier-domain flux reconstruction to scan this range for frequencies with statistically-significant support in the timestamp data, and (3) have a noise model that remains valid even for very low photon counts. The substantial advantages of the system 100 were experimentally demonstrated and were shown to have at least the ability to: (1) image a scene illuminated simultaneously by sources operating at vastly different speeds without synchronization (e.g., bulbs, projectors, multiple pulsed lasers), (2) acquire passive non-line-of-sight video, (3) record ultra-wideband video, which can be played back later at 30 Hz to show everyday motions, but can also be played a billion times slower to show the propagation of light itself, and (4) recover images of far higher signal-to-noise ratio compared to existing techniques.

The sheer amount of data involved in sensing and probing timestamp streams is substantial; even a single pixel can output tens of thousands of timestamps per second in low light, and ultrawide-bandwidth can result in requiring probing billions of frequencies. Advantageously, the system 100 is not limited by speed and can detect motions that are orders of magnitude faster than the frame rate. Additionally, because the image sensor 130 is not necessarily connected or communicating with any light source that would require synchronization, the system 100 can sense light from more than one source because the system 100 is alleviated from the need to synchronize with multiple light sources.

FIG. 8 illustrates a flowchart of a method 800 for single-photon imaging with fast probing, in accordance with another embodiment.

At block 802, the imaging module 112 receives a plurality of asynchronous, or partially asynchronous, single-photon detections from the image sensor 130 capturing a scene, as describe herein.

At block 804, the probing module 114 performs interval probing using a non-uniform fast Fourier transform, such as the Flatiron Institute Nonuniform Fast Fourier Transform (FINUFFT).

At block 806, the probing module 114 determines interval bands of frequency with the frequency content determined using the non-uniform fast Fourier transform.

At block 808, the probing module 114 performs probing measurements on only the identified interval bands in order to determine the sum of the single-photon detection values. The probing measurements within the identified interval bands can thus be used to determine whether the flux contains signals in each of the identified bands. In a particular case, the interval bands can be uniformly-spaced intervals; for example, 1 Hz, 10 Hz, 100 Hz, or the like. In other cases, the intervals can be non-uniformly spaced. However, since the CFAR bound becomes more stringent as the interval gets larger (i.e., because it is harder from frequencies to go above the bound, there is higher likelihood that frequencies would be missed). By keeping the interval fixed, the system 100 can ensure that the detection likelihood is consistent across the entire frequency range.

At block 810, in some cases, the noise module 118 identifies and removes noisy frequencies based on a predetermined probability of false alarm and removes such frequencies. In a particular case, the noise module 118 can implement a constant false alarm rate (CFAR) detector; however, any other suitable detection scheme can be used that identifies statistically significant frequencies.

At block 812, the reconstruction module 116 reconstructs a continuous-time flux function from the amplitudes and phases of detected frequencies in the probing measurements.

At block 814, the output module 122 outputs the reconstructed continuous-time flux function, or an integral thereof, to data storage 104 or the output interface 106, or both.

In the method 800, it is known that the fast Fourier transform (FFT) of a rate function λ(t) at some frequency ƒ is:

$$\frac{1}{T} {\int }_{0}^{T} {e}^{- 2 π ift} λ ( t ) dt$$

Integrating the FFT over the interval [ƒ₁, ƒ₂], it can be expected that an amplitude of this integral to be 0 if λ(t) does not have any frequency component in this interval. Evaluating the integral of the FFT over [ƒ₁, ƒ₂]:

$${\int }_{{f}_{1}}^{{f}_{2}} \frac{1}{T} {\int }_{0}^{T} {e}^{- 2 π ift} λ ( t ) dt df$$

Swapping the domain of integration:

$$\frac{1}{T} {\int }_{0}^{T} ( {\int }_{{f}_{1}}^{{f}_{2}} {e}^{- 2 π ift} df ) λ ( t ) dt$$

The inner integral has an analytical form as follows:

$$\frac{i}{2 π T} {\int }_{0}^{T} ( \frac{{e}^{- 2 π {if}_{2} t} - {e}^{- 2 π {if}_{1} t}}{t} ) λ ( t ) dt$$

The first part of the above can be approximated as follows:

$$\frac{i}{2 π T} {\int }_{0}^{T} ( \frac{{e}^{- 2 π ift}}{t} ) λ ( t ) dt = \frac{i}{2 π T} {\sum }_{k = 1}^{N} \frac{{e}^{- 2 π {ift}_{k}}}{{t}_{k}} \\ \frac{i}{2 π T} {\int }_{0}^{T ∖ b} ( \frac{{e}^{- 2 π ift}}{t} ) λ ( t ) dt = \frac{1}{T} {\sum }_{k = 1}^{N} {e}^{- 2 π {ift}_{k}} \frac{i}{2 π {t}_{k}}$$

Where g(t) can be defined as follows:

$$g ( t ) = \frac{i}{2 π t}$$

Which provides the following:

$$\frac{i}{2 π T} {\int }_{0}^{T} ( \frac{{e}^{- 2 π ift}}{t} ) λ ( t ) dt = \frac{1}{T} {\sum }_{k = 1}^{N} {e}^{- 2 π {ift}_{k}} g ( {t}_{k} )$$

The above is tantamount to computing a Nonuniform Fast Fourier Transform (NUFFT) with non-uniform points evaluated at tₖ, with function value g(tₖ) rather than 1. This sum provides the output and advantageously only has to be computed at frequencies equal to nw, ∀n∈N, where w is the window size.

With respect to the CFAR detector, the following has been used to determine the estimate, for which an estimation of noise is desired:

$$\frac{i}{2 π T} {\sum }_{k = 1}^{N} \frac{{e}^{- 2 π {if}_{2} {t}_{k}} - {e}^{- 2 π {if}_{1} {t}_{k}}}{{t}_{k}}$$

The real and imaginary components can be given by:

$$var [ R ] \approx var [ I ] \approx \frac{w N ( T )}{4 {T}^{3}}$$

Accordingly, the CFAR bound for an outlier rate of a is:

$${CDF}_{{χ}^{2}}^{- 1} ( 1 - α ) \sqrt{\frac{w N ( T )}{4 {T}^{3}}}$$

The frequency content is as described herein; for example, determining frequencies from f_min=0 Hz to f_max>10 GHz. However, in this method, probing is performed advantageously by using the non-uniform Fast Fourier (nuFFT) transform. The output of nuFFT is identical or similar to the method 200 but the computation can be orders of magnitude faster. Method 200 has computational complexity on the order of N*F, where N is the number of photons and F is the number of probed frequencies (i.e., the number of computations required is on the order of N*F). Since the photons can number in the 100s of thousands and probed frequencies can be in the billions, this is a substantial number of computations.

Applicant has determined that using the non-uniform fast Fourier transform can provide more than a thousand-fold improvement in computational efficiency with four-to-six orders of magnitude in speed increase.

As an example, typical probing can include a step size of approximately 0.1 Hz for exposures of 1 second. Thus, to probe over an example range of 0 Hz to 10 GHz, this would mean 100 billion distinct probing operations (10 GHz/0.1 Hz). In contrast, using interval bands of method 800, a step size can be increased to probe, for example, 1 Hz, 10 Hz or even 100 Hz intervals for the presence of frequencies that pass the CFAR threshold. In this way, scanning the example 0 Hz to 10 GHz range can require a total of 100 million interval-probing operations (10 GHz/100 Hz); which is 1000 times fewer.

The present embodiments use absolute timestamps which provides a substantial advantage over using relative timestamps because relative timestamps are generally only available if the image sensor (e.g., SPAD) is synchronized to a single pulsed laser source; which substantially limits the applicability of such systems.

The present embodiments also have substantial advantages over techniques that use observations applied to binned data instead of timestamps. Additionally, there are substantial advantages over approaches that merely determine emission periods instead of determining flux functions; for example, approaches that compute a pulsation period of a single celestial object, but not a flux function, and do not discard noisy frequencies or reconstruct the flux functions; which substantially limits applicability of such approaches. In addition, such approaches will generally require there to be a single light source that emits light.

The present embodiments for passive acquisition and processing of timestamp streams from, for example, free-running SPADs have many applications for dynamic imaging; for example:
completely unsynchronized, single-shot observations of ultra-fast phenomena with multiple light sources across different timescales;
passive depth imaging using uncooperative, environmental light sources;
compressive, ultra-fast video recording using sparse photon counts;
temporal “microscopes” that allow monitoring intensity fluctuations across timescales spanning the roughly 10 orders of magnitude (e.g., DC to 31 GHz) theoretically captured by SPADs; 23
amongst many others as understood by a person of skill in the art.

Further, the present embodiments can be used in any suitable computer vision technique or image processing technique based on the flux data produced by the sensor, for example, in detection, tracking, recognition, reconstruction, navigation, or the like.

While the present embodiments generally describe the probing function being a Fourier basis function, in further cases, the probing function can be, for example, a wavelet basis function or a function learned by a deep neural network.

While the present disclosure generally describes pixel-wise reconstruction and processing of flux functions, it should be understood that receiving the plurality of asynchronous, or partially asynchronous, single-photon detections and the absolute timestamp associated with each one of the received single-photon detections can include receiving single-photon detections, and the associated absolute timestamps, from a group of pixels. The group of pixels can include a neighborhood of pixels on the sensor, a patch of pixels on the sensor, all the pixels on the sensor, or the like. In such cases, the continuous-time flux function is a three-dimensional flux function, comprising two-dimensions of pixel coordinates and one-dimension of time.

It is understood that the system and methods of the present embodiments could be further integrated into other applications; for example, integrated into a microscope, a telescope, LIDAR (Light Detection and Ranging), a system for free-space optical communications, or the like. The present embodiments can also receive the detected photons from any suitable source; for example, from one or more lasers, light-emitting-diodes, projectors, natural light, artificial indoor or outdoor light sources, or the like.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A processor-implemented method for single-photon imaging, the method comprising:
receiving a plurality of asynchronous, or partially asynchronous, single-photon detections and an absolute timestamp associated with each one of the received single-photon detections;
performing probing measurements to determine a sum of values of a probing function on the single-photon detection values at each of the absolute timestamps;
reconstructing a continuous-time flux function from the probing measurements; and
outputting the reconstructed continuous-time flux function or an integral thereof.

2. The method of claim 1, wherein the probing function is performed on frequencies from 0 to a maximum recoverable frequency, or a subset thereof, where each of the frequencies are separated by a frequency step.

3. The method of claim 2, wherein the frequency step is determined as 0.6/t, where t is a total acquisition time.

4. The method of claim 1, wherein the probing function approximates the flux function up to an additive noise function.

5. The method of claim 1, wherein the probing function is a continuous-time probing function.

6. The method of claim 1, wherein the probing function is a Fourier basis function and the continuous-time flux function is reconstructed from the amplitudes and phases of detected frequencies.

7. The method of claim 6, wherein the Fourier basis function is p_{ƒ}(t)=e^{-j2πƒt}.

8. The method of claim 1, wherein flux frequencies above ½q are ignored, where q is a given timing resolution.

9. The method of claim 1, further comprising identifying and removing noisy frequencies based on a predetermined probability of false alarm.

10. The method of claim 9, wherein the predetermined probability of false alarm is determined by detecting whether a given probed frequency contributes to the flux function by determining if a corresponding amplitude is greater than a predetermined threshold.

11. The method of claim 1, wherein reconstructing the continuous-time flux function comprises summing, over the detected frequencies, corresponding Fourier basis functions scaled by their amplitudes and shifted by their associated phases.

12. The method of claim 11, wherein reconstructing the continuous-time flux function comprises determining [symbol] A_{ƒ} cos(2πƒt+φ_{ƒ}), where ƒ is the detected frequencies, [symbol] _{used} are the set of detected frequencies that are used, A_{ƒ} is the amplitude at each frequency, and φ_{ƒ} is the phase at each frequency.

13. The method of claim 12, further comprising identifying one or more dominant frequencies in the set of detected frequencies and adding higher harmonics of the dominant frequencies to the set of detected frequencies that are used.

14. The method of claim 1, wherein receiving the plurality of asynchronous, or partially asynchronous, single-photon detections and the absolute timestamp associated with each one of the received single-photon detections comprises receiving single-photon detections, and the associated absolute timestamp, from a group of pixels, and wherein the continuous-time flux function comprises a three-dimensional flux function.

15. The method of claim 14, wherein the group of pixels comprises a neighborhood of pixels on a sensor, a patch of pixels on the sensor, or all the pixels on the sensor.

16. The method of claim 1, wherein the reconstructed continuous-time flux function, or the integral thereof, is used for computer vision or image processing tasks.

17. The method of claim 1, wherein the absolute timestamp is a frame number within a sequence captured by an image sensor.

18. A system for single-photon imaging, the system comprising one or processors and a data storage, the data storage comprising instructions for the one or more processors to execute:
an imaging module to receive, from a single photon detector, a plurality of asynchronous, or partially asynchronous, single-photon detections and an absolute timestamp associated with each one of the received single-photon detections;
a probing module to perform probing measurements to determine a sum of values of a probing function on the single-photon detection values at each of the absolute timestamps;
a reconstruction module to reconstruct a continuous-time flux function from the probing measurements; and
an output module to output the reconstructed continuous-time flux function or an integral thereof.

19. The system of claim 18, wherein the probing function is performed on frequencies from 0 to a maximum recoverable frequency, where each of the frequencies are separated by a frequency step.

20. The system of claim 18, wherein the probing function is a continuous-time probing function.

21. The system of claim 18, wherein the probing function is a Fourier basis function and the continuous-time flux function is reconstructed from the amplitudes and phases of detected frequencies.

22. The system of claim 18, wherein the one or more processors further execute a noise module to identify and remove noisy frequencies based on a predetermined probability of false alarm.

23. The system of claim 18, wherein reconstructing the continuous-time flux function comprises summing, over the detected frequencies, the amplitudes and a cosine of the associated phases.

24. The system of claim 23, wherein reconstructing the continuous-time flux function comprises determining [symbol] A_{ƒ} cos(2πƒt+φ_{ƒ}), where ƒ is the detected frequencies, [symbol] _{used} are the set of detected frequencies that are used, A_{ƒ} are the amplitudes at each frequency, and φ_{ƒ} are the phases at each frequency.

25. The system of claim 18, wherein receiving the plurality of asynchronous single-photon detections from the single photon detector comprises performing scanning of a scene.

26. The system of claim 18, wherein the single photon detector comprises a one-dimensional or two-dimensional array of single-photon avalanche diodes.

27. The system of claim 18, wherein the reconstructed continuous-time flux function, or the integral thereof, is used for computer vision or image processing tasks.

28. The system of claim 18, wherein the absolute timestamp is a frame number within a sequence captured by an image sensor.

29. A processor-implemented method for single-photon imaging, the method comprising:
receiving a plurality of asynchronous, or partially asynchronous, single-photon detections and an absolute timestamp associated with each one of the received single-photon detections;
performing interval probing using a non-uniform fast Fourier transform to determine frequency content;
determining interval bands with the frequency content determined using the non-uniform fast Fourier transform;
performing probing measurements using only the identified interval bands to determine a sum of values of a probing function on the single-photon detection values at each of the absolute timestamps;
reconstructing a continuous-time flux function from the probing measurements; and
outputting the reconstructed continuous-time flux function or an integral thereof.
